(19) United States
(12) Patent Application Publication
(10) Pub. No.: US 2021/0392133 A1
(43) Pub. Date: Dec. 16, 2021

(54) Dynamic Authentication Control System

(71) Applicant: Bank of America Corporation, Charlotte, NC (US)

(72) Inventors: Jinna Kim, Charlotte, NC (US); Elizabeth R. Liuzzo, Charlotte, NC (US); Albena N. Fairchild, Spruce Pine, NC (US)

(21) Appl. No.: 16/897,651

(22) Filed: Jun. 10, 2020

(51) Int. Cl. H04L 29/06; G06N 20/00; G06N 5/04; G06K 9/00

(52) U.S. Cl. CPC H04L 63/0861; G06N 20/00; H04L 2463/082; G06K 9/00087; G06K 9/00892; G06N 5/04

(57) ABSTRACT

Systems for dynamically controlling authentication data are presented. In some examples, registration data may be received. The registration data may include user data, contact information, and authentication data which may include deoxyribonucleic acid (DNA) data of a user. In some arrangements, a request to process an event may be received. The request may include event details which may be used to determine or identify an authentication tier of the event. Based on the identified authentication tier, one or more authentication factors for request may be dynamically identified. The request for authentication factors may be transmitted to a user device and authentication response data may be received. The authentication response data may be compared to the authentication data received at registration (or otherwise pre-stored) to determine whether a match exists. If the data matches, the event may be authorized for processing. If not, the event process request may be denied.

### BACKGROUND

Aspects of the disclosure relate to electrical computers, systems, and devices for providing and performing dynamic authentication control functions.

Maintaining security of personal information and controlling use of authentication information in order to avoid unauthorized access is a significant priority for many users. This becomes even more important as users try to balance connectivity and privacy. As more user data is stored electronically, and more users are relying on authentication factors to execute functions such as access accounts, process transactions, and the like, users and service providers are constantly developing new authentication factors and processes for authentication. When selecting authentication factors, users are often faced with trying to identify unique data or responses to act as authenticating information. Accordingly, use of the deoxyribonucleic acid (DNA) data of a user, alone or in combination with other factors, may be beneficial in providing a unique and difficult to replicate authenticating factor.

Further, users often rely on static forms of authentication or authentication factors to access data or process events. For instance, factors such as passwords, fingerprints, and the like, that are repeatedly used to authenticate a user may be accessed or replicated by unauthorized users to gain access to information or systems. Accordingly, by dynamically modifying which authentication factors are requested to access a system or process an event, additional security is provided.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical problems associated with dynamically controlling authentication.

In some examples, registration data may be received. The registration data may include user data, contact information, and authentication data. In some examples, the authentication data may include a plurality of different types of authentication data. In some arrangements, the authentication data may include at least deoxyribonucleic acid (DNA) data of a user.

In some arrangements, a request to process an event may be received. The request may include event details which may be used to determine or identify an authentication tier of the event. Based on the identified authentication tier, one or more authentication factors for request may be dynamically identified. The request for authentication factors may be transmitted to a user device and authentication response data may be received. The authentication response data may be compared to the authentication data received at registration (or otherwise pre-stored) to determine whether a match exists. If the data matches, the event may be authorized for processing. If not, the event process request may be denied.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for implementing dynamic authentication control functions in accordance with one or more aspects described herein;

FIGS. 2A-2F depict an illustrative event sequence for implementing dynamic authentication control functions in accordance with one or more aspects described herein;

FIG. 3 depicts an illustrative method for implementing and using dynamic authentication control functions according to one or more aspects described herein;

FIG. 4 illustrates one example user interface that may be generated according to one or more aspects described herein;

FIG. 5 illustrates one example user interface that may be generated according to one or more aspects described herein;

FIG. 6 illustrates one example environment in which various aspects of the disclosure may be implemented in accordance with one or more aspects described herein; and

FIG. 7 depicts an illustrative block diagram of workstations and servers that may be used to implement the processes and functions of certain aspects of the present disclosure in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, customers and service providers are continually trying to balance connectivity and privacy. Providers strive to find unique ways to authenticate users, process events, and the like, that maintain privacy and security of customer data. Users also strive to identify and implement unique authenticating factors that will be difficult to replicate by an unauthorized actor.

Accordingly, the use of deoxyribonucleic acid (DNA) data of a user, used alone or in combination, may be a unique form of authentication for the user. In some examples, users may provide DNA data to a system during, for example, a registration process. The DNA may be stored with other authenticating factors. In some arrangements, the DNA or DNA in combination with other authenticating factors may be converted to code to generate a DNA tag that may be provided to the user for use as an authenticating factor.

In some examples, when a user requests to authenticate, process an event, or the like, the system may dynamically identify one or more authentication factors for request. In some examples, at least one factor identified may be DNA or DNA related (e.g., DNA tag, or the like). Accordingly, by dynamically identifying the authenticating factors that will be provided for any given event, and by using the unique characteristics of a user's DNA, enhanced security may be provided to the user.

These and various other arrangements will be discussed more fully below.

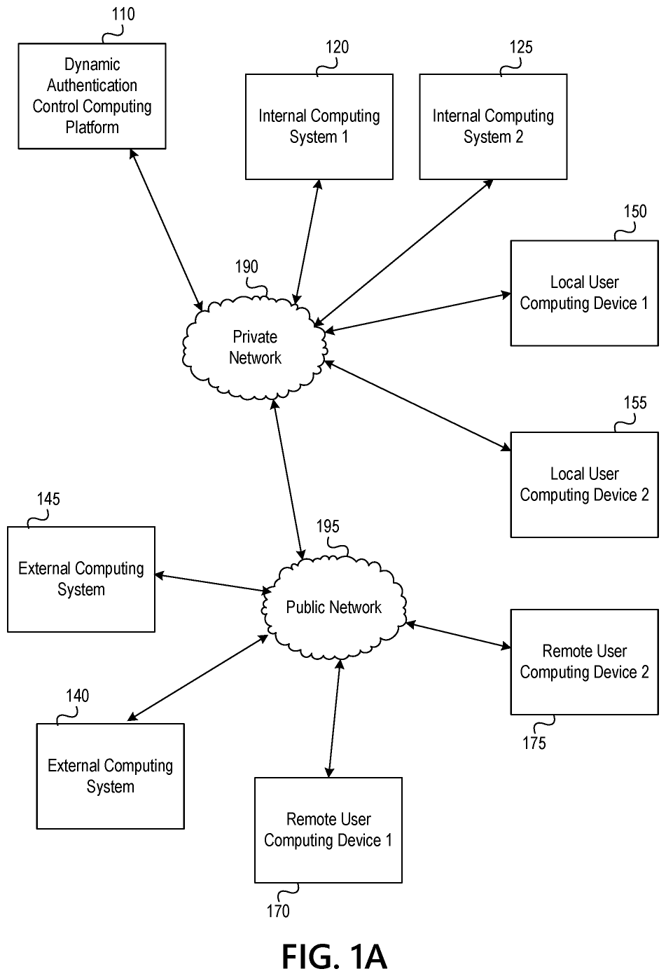

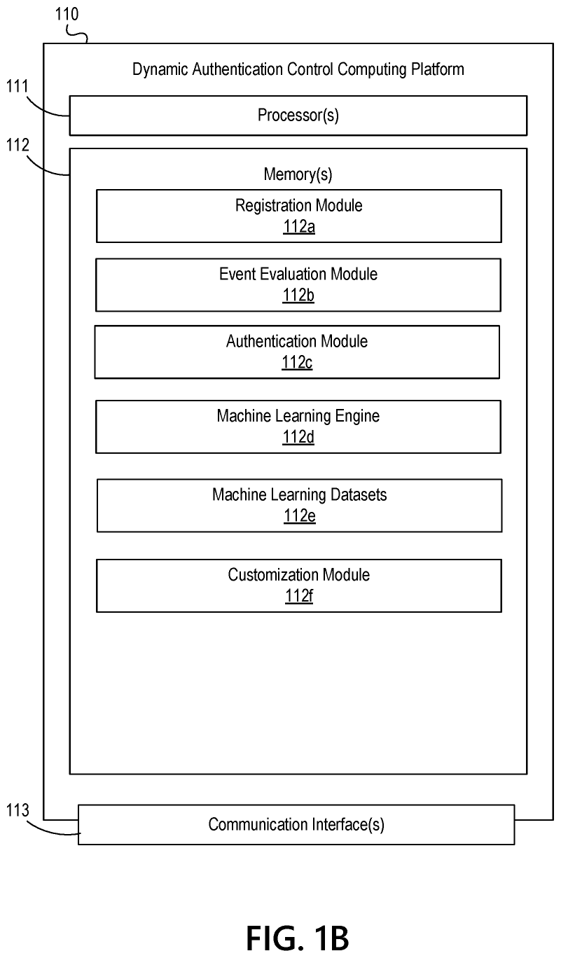

FIGS. 1A-1B depict an illustrative computing environment for implementing dynamic authentication control functions in accordance with one or more aspects described herein. Referring to FIG. 1A, computing environment 100 may include one or more computing devices and/or other computing systems. For example, computing environment 100 may include dynamic authentication control computing platform 110, internal computing system 1 120, internal computing system 2 125, external computing system 140, external computing system 145, a first local user computing device 150, a second local user computing device 155, a first remote user computing device 170, and a second remote user computing device 175. Although two internal computing systems 120, 125, two external computing systems 140, 145, two local user computing device 150, 155 and two remote user computing device 170, 175 are shown, more or fewer devices may be used without departing from the invention.

Dynamic authentication control computing platform 110 may be configured to provide intelligent, dynamic, authentication control functions. Dynamic authentication control computing platform 110 may be a computer system that includes one or more computing devices (e.g., servers, server blades, or the like) and/or other computer components (e.g., processors, memories, communication interfaces) that may be used to implement machine learning algorithms, or the like to recognize patterns and generate or identify one or more types of authentication data, forms of authentication, or the like, to request in response to a request to process an event or transaction.

For instance, a user or plurality of users may register with the dynamic authentication control computing platform 110. Registration may include providing identifying information, such as name, contact information, and the like, as well as one or more authenticating factors or types of authenticating factors. In some examples, authenticating factors may include deoxyribonucleic acid (DNA) data from the user. The DNA data may be retrieved from a DNA data store or bank (e.g., associated with, for instance, genealogy services), may be provided by the user via a sample or swab (e.g., blood, saliva, hair, or the like) provided at a self-service kiosk, at a banking center or location, or the like. The use of DNA, and other forms or pieces of authentication data discussed herein, may be used with the permission of the user and upon a user opting in or requesting access to the arrangements described and providing registration information to enable the dynamic authentication control functions.

In some examples, users may provide additional authentication data or types of authentication data. For instance, biometric data such as fingerprint, voiceprint, facial recognition, heart rate or heart rate range, blood pressure or blood pressure range, speech pattern, voiceprint, typing pattern, or the like. Additionally or alternatively, authentication data such as username and password or personal identification number (PIN) may be received, challenge questions and associated answers may be captured, and the like. In some examples, data such as heart rate or heart rate pattern or historical data, blood pressure or blood pressure pattern data, or the like, may be captured. In some examples, this data may be captured by one or more user devices, such as a mobile device of the user, wearable device of the user, or the like.

In some arrangements, machine learning may be used to generate authentication data based on publicly available information associated with a user. For instance, data captured from social media sites, and the like, may be used to generate authentication data requests (e.g., challenge questions that are not pre-stored or selected, or the like).

As will be discussed more fully herein, a user may opt-in to using the dynamic authentication processes discussed herein. In some examples, a user may enable or disable the dynamic authentication processes as desired (e.g., via a mobile application executing on a smartphone, via an online application, via a self-service kiosk, or the like).

In some arrangements, the dynamic authentication control computing platform 110 may evaluate a request for event processing (e.g., request to process a transaction, request to authenticate a user to access data, or the like) and may determine or identify one or more authentication factors for request based on characteristics of the event. For instance, amount of event, type of event, parties to the event, and the like, may be used to identify how many and what type of authenticating factors may be used to authenticate the user and process the event. In some examples, machine learning may be used to analyze data to identify the authenticating factors.

In some examples, the system may dynamically modify a number or type of authenticating factors to use to process an event. For instance, the dynamic authentication control computing platform 110 may dynamically modify the requested authentication data based on, for instance, authentication factors in combination with other factors. For instance, DNA may be a root authentication factor but may be used in combination with other factors, such as biometrics, PIN, and the like, to enhance security. The additional factors identified may be based on, for instance, recency of use by the user (e.g., last two authentication factors used), frequency of use, and the like.

Upon receiving a request to authenticate a user, process an event, or the like, the dynamic authentication control computing platform 110 may generate an authentication data request. In some examples, the authentication data request may be based on a determined authentication requirement level or tier. The authentication data request may include one or more different types of authentication data. The authentication data request may be transmitted to a user computing device, such as remote user computing device 170, 175, and may be displayed by the device. The user may then provide authentication response data via the remote user computing device 170, 175, which may be transmitted to the dynamic authentication control computing platform 110 for evaluation.

Based on the evaluation of the received authentication response data, the user may be authenticated, the event may be authorized for processing, or the like, if the authentication data provides a sufficient match (e.g., at least a predetermined threshold match). Alternatively, if the authentication response data is not at least a predetermined threshold match, the user might not be authenticated, the requested event processing may be denied, or the like.

Internal computing system 1 120 and internal computing system 2 125 may be or include various systems internal to the enterprise or entity that may host or execute the dynamic authentication control computing platform 110. For instance, internal computing system 1 120 and/or internal computing system 2 125 may host or execute one or more applications enabling or controlling access to accounts (e.g., online banking applications, mobile banking applications, and the like), controlling or enabling payments (e.g., mobile payment applications), may store data associated with one or more users and/or one or more user accounts, may store payment history data of one or more users or entities (e.g., payments to vendors, or the like), and the like.

External computing system 140 and/or external computing system 145 may be or include various systems or devices external to the enterprise or entity that may host or execute the dynamic authentication control computing platform 110. For instance, external computing system 140 and/or external computing system 145 may host or execute one or more applications, systems, or the like, storing or controlling access to publicly available information, such as a social media sites, and the like.

External computing system 140 and/or external computing system 145 may further include systems at which a request to process an event may be received. For instance, external computing system 140, 145 may include a point-of-sale system at a retailer at which a user is requesting to process an event.

Local user computing device 1 150 and local user computing device 2 155 may be enterprise computing devices in communication with one or more other computing devices or systems. For instance, local user computing device 1 150 and/or local user computing device 2 155 may be computing devices configured to communicate with dynamic authentication control computing platform 110 to control parameters associated with dynamic authentication control computing platform 110, and the like.

Remote user computing device 1 170 and remote user computing device 2 175 may be computing devices associated with a user outside of the enterprise and may, in some examples, be user computing devices (e.g., desktop computers, laptop computers, tablet computers, smartphones, and the like) that may be used to request registration with the dynamic authentication control computing platform 110, receive user input including authentication response data, receive and display notifications, and the like. In some examples, remote user computing device 170, 175 may include wearable devices configured to communicate with one or more other devices and capture and/or transmit data (e.g., heart rate data, blood pressure data, walking gait data, or the like).

Computing environment 100 also may include one or more computing platforms. For example, and as noted above, computing environment 100 may include dynamic authentication control computing platform 110. As illustrated in greater detail below, dynamic authentication control computing platform 110 may include one or more computing devices configured to perform one or more of the functions described herein. For example, dynamic authentication control computing platform 110 may include one or more computers (e.g., laptop computers, desktop computers, servers, server blades, or the like).

As mentioned above, computing environment 100 also may include one or more networks, which may interconnect one or more of dynamic authentication control computing platform 110, internal computing system 1 120, internal computing system 2 125, external computing system 140, external computing system 145, local user computing device 150, local user computing device 155, remote user computing device 170, and/or remote user computing device 175. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization or enterprise (e.g., a corporation, financial institution, educational institution, governmental institution, or the like) and may interconnect one or more computing devices associated with the organization. For example, dynamic authentication control computing platform 110, internal computing system 1 120, internal computing system 2 125, local user computing device 150, and local user computing device 155, may be associated with an organization or enterprise (e.g., a financial institution), and private network 190 may be associated with and/or operated by the organization, and may include one or more networks (e.g., LANs, WANs, virtual private networks (VPNs), or the like) that interconnect dynamic authentication control computing platform 110, internal computing system 1 120, internal computing system 2 125, local user computing device 150, local user computing device 155, and one or more other computing devices and/or computer systems that are used by, operated by, and/or otherwise associated with the organization or enterprise. Public network 195 may connect private network 190 and/or one or more computing devices connected thereto (e.g., dynamic authentication control computing platform 110, internal computing system 1 120, internal computing system 2 125, local user computing device 150, local user computing device 155) with one or more networks and/or computing devices that are not associated with the organization. For example, external computing system 140, external computing system 145, remote user computing device 170, remote user computing device 175, might not be associated with an organization or enterprise that operates private network 190 (e.g., because external computing system 140, external computing system 145, remote user computing device 170, and/or remote user computing device 175, may be owned, operated, and/or serviced by one or more entities different from the organization that operates private network 190, one or more customers of the organization, one or more employees of the organization, public or government entities, and/or vendors of the organization, rather than being owned and/or operated by the organization itself), and public network 195 may include one or more networks (e.g., the internet) that connect external computing system 140, external computing system 145, remote user computing device 170, and/or remote user computing device 175, to private network 190 and/or one or more computing devices connected thereto (e.g., dynamic authentication control computing platform 110, internal computing system 1 120, internal computing system 2 125, local user computing device 150, local user computing device 155).

Referring to FIG. 1B, dynamic authentication control computing platform 110 may include one or more processors 111, memory 112, and communication interface 113. A data bus may interconnect processor(s) 111, memory 112, and communication interface 113. Communication interface 113 may be a network interface configured to support communication between dynamic authentication control computing platform 110 and one or more networks (e.g., private network 190, public network 195, or the like). Memory 112 may include one or more program modules having instructions that when executed by processor(s) 111 cause dynamic authentication control computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of dynamic authentication control computing platform 110 and/or by different computing devices that may form and/or otherwise make up dynamic authentication control computing platform 110.

For example, memory 112 may have, store and/or include registration module 112a. Registration module may store instructions and/or data that may cause or enable the dynamic authentication control computing platform 110 to receive registration data from one or more users (e.g., via a user computing device such as remote user computing device 170, 175). In some examples, the registration information may include identifying information of the user, contact information of the user, account information associated with one or more accounts of the user (e.g., for use in processing events such as transactions), and the like. In some examples, the registration information may further include authentication data that may be stored by dynamic authentication control computing platform 110 (or other internal device such as internal computing system 1 120, internal computing system 2 125, or the like) for later comparison and authentication/authorization.

In some arrangements, the received authentication data may include one or more different types of data, such as biometric data, such as DNA, fingerprint, facial scan, voiceprint, and the like, username and password or PIN data, challenge question data, data identifying a particular user device such as a smartphone, wearable device, or the like, having a signal detectable by another device and used to authenticate a user, or the like. As discussed herein, arrangements described may request user authentication data including one or more different types of data (e.g., biometric plus username and password plus device, or the like).

In some examples, the authentication data provided at registration may be retrieved from a system or device pre-storing the authentication data. For instance, DNA data may be retrieved (e.g., with permission of the user) from a genealogy database to which the user previously provided a DNA sample).

In some arrangements, authentication data may be received from one or more sensors or applications executing on, for example, a user device. For instance, a smartphone, wearable device, or the like, of the user may capture user data (e.g., heart rate data, blood pressure data, sleep pattern data, or the like) via one or more sensors in the user device. This data may be stored by the registration module 112a and used to authenticate a user, authorize processing an event, or the like.

Registration module 112a may store instructions or data that may further cause the dynamic authentication control computing platform 110 to generate a DNA tag. As will be discussed herein, a DNA tag may be generated from DNA data or DNA data in combination with other authenticating factors. The data may be converted to code which may then be used to authenticate a user.

Dynamic authentication control computing platform 110 may further have, store and/or include event evaluation module 112b. Event evaluation module 112b may store instructions and/or data that may cause or enable the dynamic authentication control computing platform 110 to receive a request to process an event, such as a transaction, request to authenticate a user (e.g., at a self-service kiosk), or the like, and extract and evaluate event details. For instance, upon receiving the request to process the event, the event evaluation module 112b may extract details such as parties to the event (e.g., vendor, user requesting the event, or the like), amount of the event, type of event, and the like. Based on the event details, the event evaluation module 112b may identify, e.g., based on machine learning, a level or tier of authentication requirements. For instance, if an event is below a first threshold amount, a first level of authentication requirements may be identified. If the event is at or above the first threshold amount, a second, different tier or level may be identified. Although two levels or tiers are described, more tiers may be used without departing from the invention.

A request for authentication data may be generated by authentication module 112c. Authentication module 112c may store instructions and/or data that may cause or enable the dynamic authentication computing platform 110 to generate a request for authentication data based on the identified level or tier of authentication requirements. For instance, a first level may have first authentication requirements including, for example, a number of authentication factors to request, a type of authentication factors to request, and the like. A second level may have a different number of authentication factors to request and/or different types of authentication factors to request. Accordingly, the authentication module 112c may identify a number of authentication factors to request and/or a type of authentication factors to request.

In some examples, the authentication factors to request and/or number of factors to request, as well as the level or tier of authentication, may be determined or identified based on machine learning. Accordingly, dynamic authentication control computing platform 110 may have, store and/or include a machine learning engine 112d and machine learning datasets 112e. Machine learning engine 112d and machine learning datasets 112e may store instructions and/or data that may cause or enable dynamic authentication control computing platform 110 to analyze data to identify patterns or sequences within event details, authentication history, and the like, to identify an appropriate level of authentication and/or a number of authentication factors to request and/or types of authentication factors to request. The machine learning datasets 112e may be generated based on analyzed data (e.g., data from previously received data, and the like), raw data, and/or received from one or more outside sources.

The machine learning engine 112d may receive data and, using one or more machine learning algorithms, may generate one or more machine learning datasets 112e. Various machine learning algorithms may be used without departing from the invention, such as supervised learning algorithms, unsupervised learning algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and the like. Additional or alternative machine learning algorithms may be used without departing from the invention.

Based on outputs from the machine learning engine, the authentication module 112c may generate a request for authentication data (e.g., including a number and/or type of authentication factors, specific authentication factors, or the like), and transmit the request to a user device, such as remote user computing device 170, 175. The request for authentication data may be displayed by a display of the remote user computing device 170, 175, and user input may be received providing authentication response data. The authentication response data may correspond to the authentication data requested. The authentication response data may be transmitted from the remote user computing device 170, 175 to the authentication module and compared to pre-stored data (e.g., data provided at registration), generated data (e.g., data generated from publicly available sources), and the like, to determine whether to authorize processing the event, authenticate the user, and the like. The authentication module 112c may generate and transmit one or more instructions or commands authorizing or denying the request, one or more notifications indicating an outcome of the comparison, and the like.

Dynamic authentication control computing platform 110 may further have, store and/or include customization module 112f. Customization module 112f may store instructions and/or data that may cause or enable the dynamic authentication control computing platform 110 to generate, transmit and cause to display one or more interactive user interfaces enabling a user to customize one or more aspects of dynamic authentication discussed herein. For instance, a user may customize types of authentication factors, number of authentication factors, factors for determining different levels of authentication requirements, enable or disable use of DNA as an authentication factor, and the like.

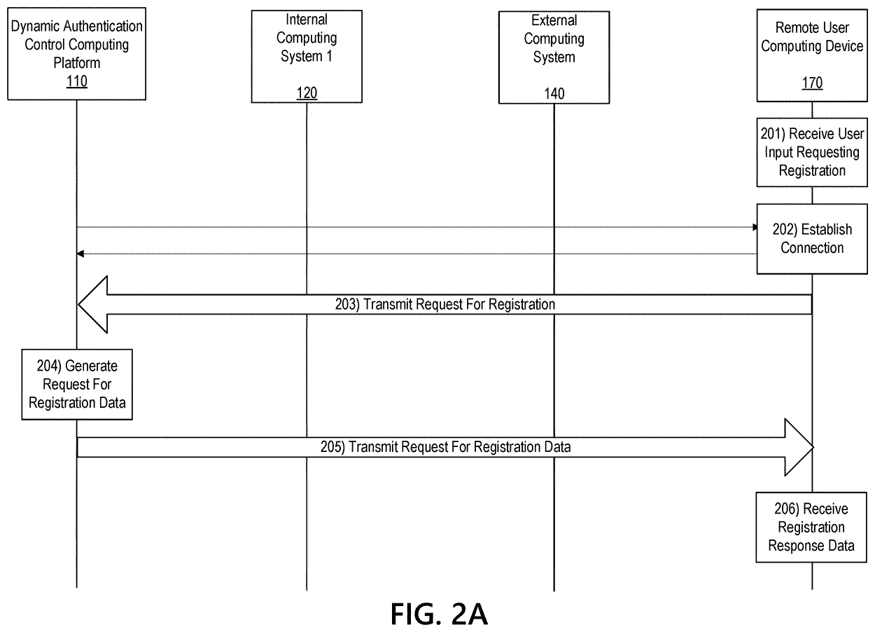

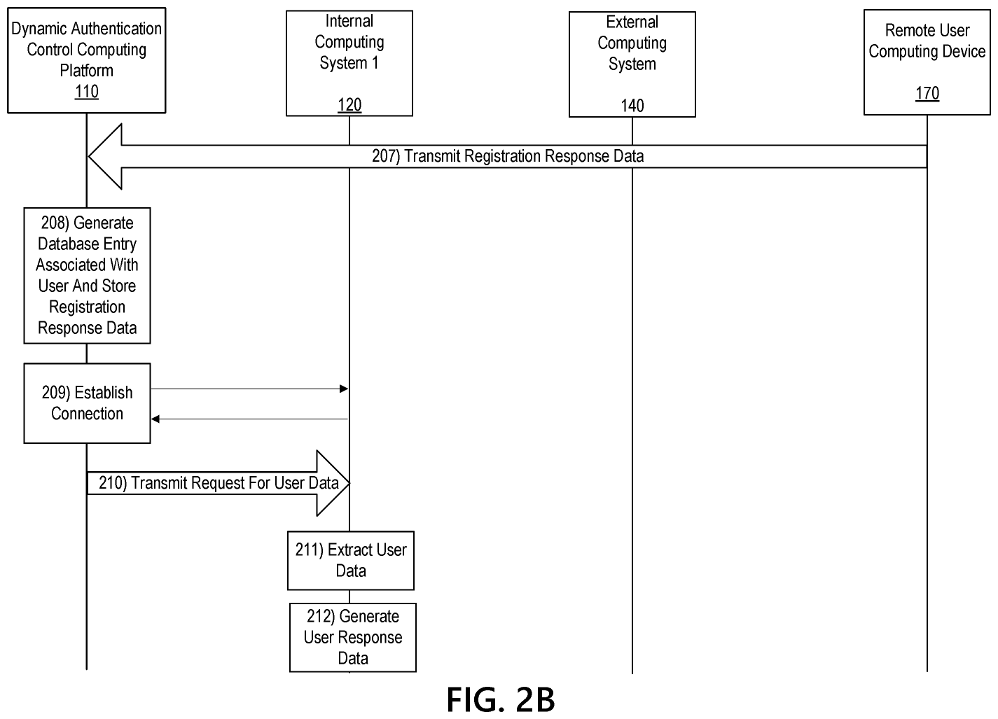

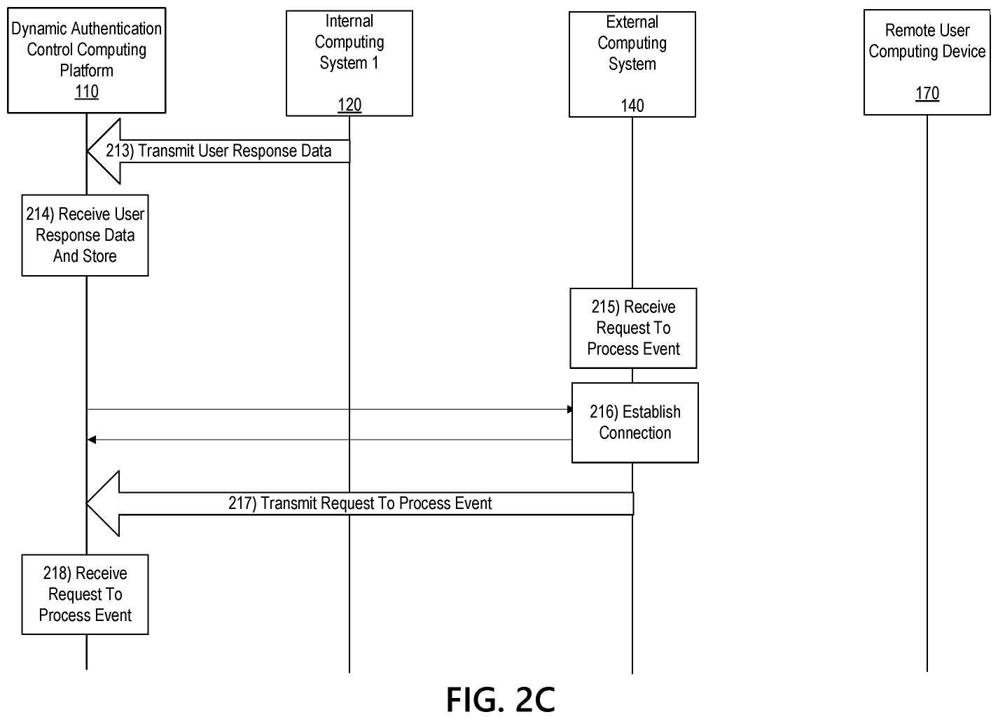

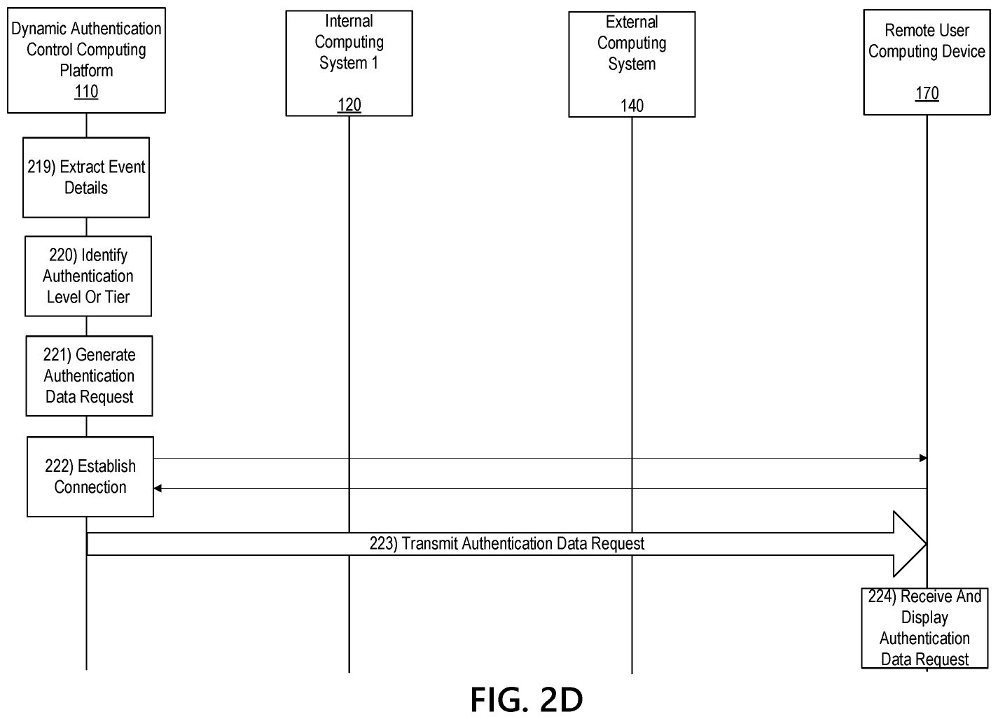

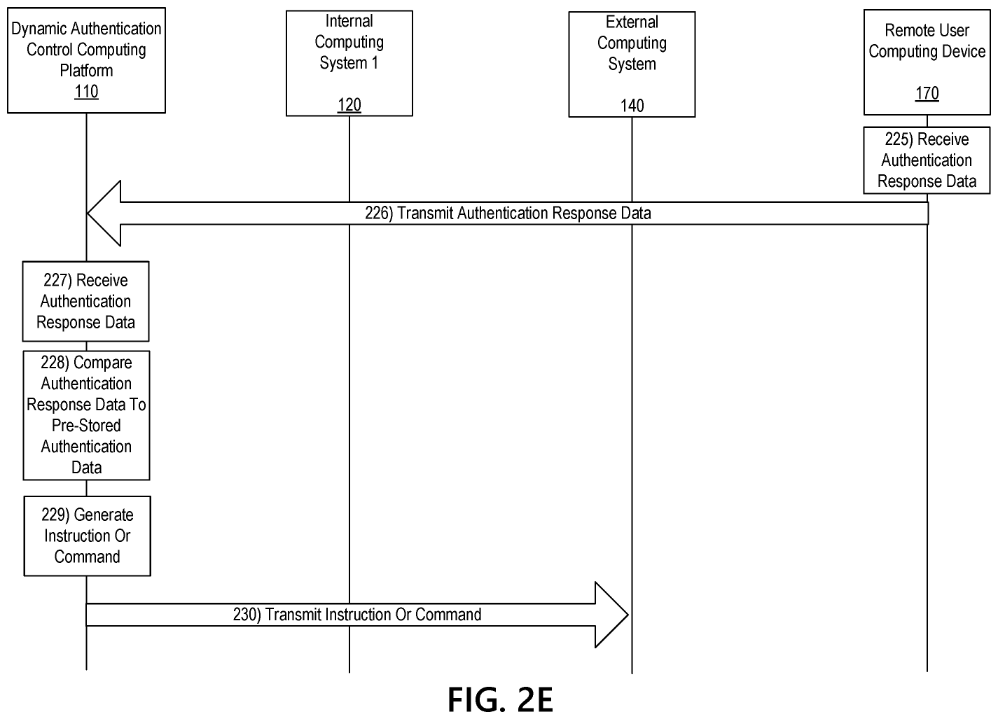

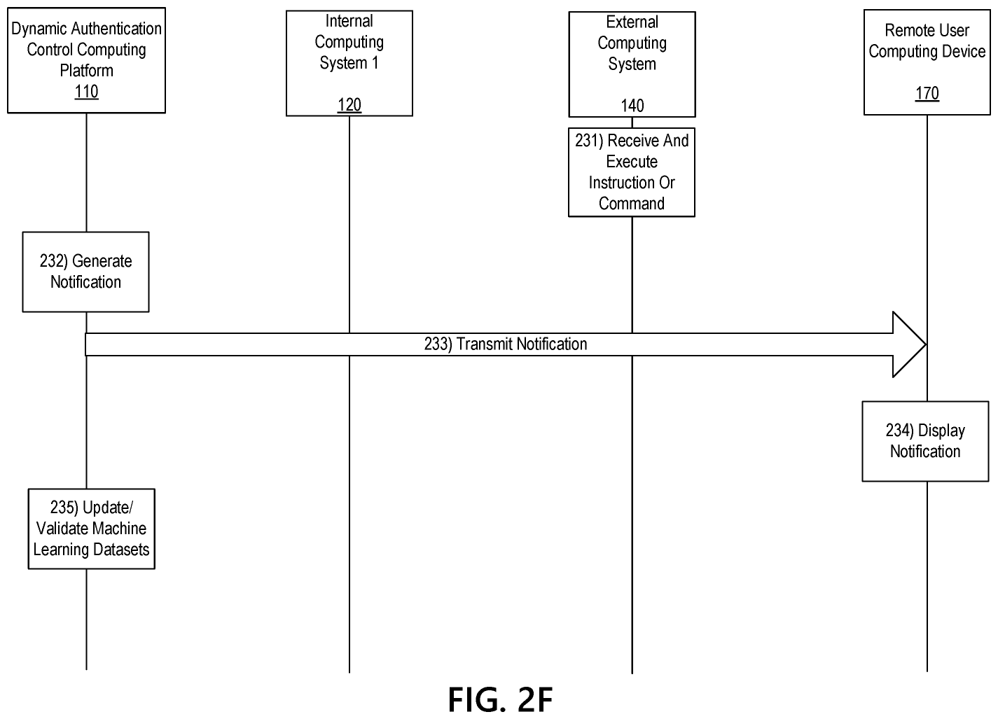

FIGS. 2A-2F depict one example illustrative event sequence for implementing dynamic authentication control functions in accordance with one or more aspects described herein. The events shown in the illustrative event sequence are merely one example sequence and additional events may be added, or events may be omitted, without departing from the invention.

With reference to FIG. 2A, at step 201, user input requesting registration (e.g., for dynamic authentication) may be received by a user computing device, such as remote user computing device 170. The user input may be provided via an application executing on the remote user computing device 170, by an online application accessed via the remote user computing device, or the like.

At step 202, a connection may be established between remote user computing device 170 and dynamic authentication control computing platform 110. For instance, a first wireless connection may be established between the dynamic authentication control computing platform 110 and remote user computing device 170. Upon establishing the first wireless connection, a communication session may be initiated between dynamic authentication control computing platform 110 and remote user computing device 170.

At step 203, the request for registration may be transmitted from remote user computing device 170 to dynamic authentication control computing platform 110. For instance, the request for registration may be transmitted during the communication session initiated upon establishing the first wireless connection.

At step 204, the request for registration may be received and processed, and a request for registration data may be generated. For instance, a request for user information, contact information, authentication data, and the like, may be generated. The request for registration data may include a request for a plurality of different authentication metrics, different types of metrics, and the like.

At step 205, the request for registration data may be transmitted from dynamic authentication control computing platform 110 to remote user computing device 170. In some examples, the request for registration data may be transmitted during the communication session initiated upon establishing the first wireless connection. Alternatively, if a wireless connection is not active, another wireless connection may be establishing and/or communication session initiated.

At step 206, the request for registration data may be received by remote user computing device 170 and registration response data may be received via remote user computing device 170. For instance, user identifying data, authentication data, and the like, may be received by remote user computing device 170 and used to generate registration response data. As discussed herein, authentication data may include biometric data (e.g., facial image, fingerprint, voice print, heart rate, and the like) captured via one or more sensors on remote user computing device 170, retrieved from sensors on another device of the user (e.g., a linked wearable device that may be remote user computing device 175, or the like), username and password or PIN data, challenge question response data, and the like. In some examples, the authentication data may include DNA data. The DNA data may be captured from a sample provided by the user via a sensor (e.g., at a testing facility, in remote user computing device 170, or the like) or pre-stored DNA data may be retrieved from a database, such as databases associated with genealogy sites. If DNA data is pre-stored, the registration response data may include permission to retrieve the data. Additionally or alternatively, the registration response data may include permission by the user for the dynamic authentication control computing platform 110 to retrieve other user information (e.g., account information, authentication data, or the like) from other internal systems, such as internal computing system 120.

With reference to FIG. 2B, at step 207, the registration response data may be transmitted from remote user computing device 170 to dynamic authentication control computing platform 110. At step 208, the registration response data may be received and a database entry may be generated for the user. The database entry may include the received registration response data including any authentication data received.

At step 209, if the user has authorized dynamic authentication control computing platform 110 to retrieve user data from other internal systems, a connection may be established between dynamic authentication control computing platform 110 and internal computing system 120. For instance, a second wireless connection may be established between the dynamic authentication control computing platform 110 and internal computing system 1 120. Upon establishing the second wireless connection, a communication session may be initiated between dynamic authentication control computing platform 110 and internal computing system 1 120.

At step 210, a request for user data may be transmitted from dynamic authentication control computing platform 110 to internal computing system 1 120. For instance, the request for user data may be transmitted during the communication session initiated upon establishing the second wireless connection.

At step 211, the request for user data may be received by internal computing system 1 120 and the requested user data may be extracted from one or more databases. For instance, user data such as account data, transaction history data, authentication data, and the like, may be extracted. At step 212, user response data may be generated based on the extracted data.

With reference to FIG. 2C, at step 213, the user response data may be transmitted from internal computing system 1 120 to dynamic authentication control computing platform 110. For instance, the user response data may be transmitted during the communication session established upon initiating the second wireless connection. Alternatively, if a wireless connection is not active, another wireless connection may be establishing and/or communication session initiated.

At step 214, the user response data may be received by dynamic authentication control computing platform 110 and stored (e.g., in the database entry created at step 208).

At step 215, a request to process an event may be received by an external computing system 140. For instance, a user may request event processing via a point-of-sale system at a retailer.

At step 216, a connection may be established between dynamic authentication control computing platform 110 and external computing system 140. For instance, a third wireless connection may be established between the dynamic authentication control computing platform 110 and external computing system 140. Upon establishing the third wireless connection, a communication session may be initiated between dynamic authentication control computing platform 110 and external computing system 140.

At step 217, the request to process the event may be transmitted from external computing system 140 to dynamic authentication control computing platform 110. The request to process the event may include event details such as amount, type, vendor name, user name or identifier, and the like.

At step 218, the request to process the event may be received by dynamic authentication control computing platform 110.

With reference to FIG. 2D, at step 219, event details may be extracted from the received request to process the event. At step 220, based on the event details, a tier or level of authentication may be determined or identified. In some examples, machine learning may be used to evaluate event details, user data, and the like, to identify a tier or level of authentication required for authorizing the event, authenticating the user, or the like. For instance, historical data associated with user events may be used, with the event details, to identify a pattern or sequence in order to determine an appropriate level of authentication. This may enable customization of authentication levels based on particular users. For instance, users who often make high end purchases (e.g., purchases over a predetermined amount) may have a different threshold amount for determining a level of authentication than users who rarely make high end purchases (e.g., purchases over a predetermined amount). In another example, for users who frequently use a debit card for purchases, a different level of tier may be identified for debit card purchases vs. credit card purchases. In another example, the level associated with debit card purchases for user 1 may be different than a level for debit card purchases for user 2 based on historical data of each user. Accordingly, use of machine learning enables use of vast amounts of data to identify sequences and determine the authentication requirements for the particular event processing request.

At step 221, an authentication data request may be generated. For instance, based on the determined or identified level or tier of authentication requirements, a request for authentication data may be generated. The request for authentication data may include particular types of authentication data, a particular number of authentication metrics, and the like. In some examples, machine learning may be used to generate the authentication data request. For instance, machine learning may be used to analyze event data, historical data, the determined level or tier, and the like, to identify patterns or sequences that identify particular types of authentication data to request, a number of factors to request, and the like. For instance, machine learning may be used to determine that, based on the determined level or tier, three forms of authentication may be required and the particular three forms may be identified dynamically based on, for instance, recency of use by the user, frequency of use, or the like.

At step 222, a connection may be established between dynamic authentication control computing platform 110 and remote user computing device 170. For instance, a fourth wireless connection may be established between the dynamic authentication control computing platform 110 and remote user computing device 170. Upon establishing the fourth wireless connection, a communication session may be initiated between dynamic authentication control computing platform 110 and remote user computing device.

At step 223, the generated authentication data request may be transmitted from the dynamic authentication control computing platform to remote user computing device 170. For instance, the authentication data request may be transmitted during the communication session initiated upon establishing the fourth wireless connection.

At step 224, the authentication data request may be received by remote user computing device 170 and displayed by a display of the remote user computing device 170.

With reference to FIG. 2E, at step 225, authentication response data may be received by remote user computing device 170. For instance, in response to the displayed request to provide authentication data, the user may input one or more responses including the requested authentication data. In some examples, the user may input via a keyboard or touchscreen. Additionally or alternatively, one or more sensors may be used to capture data (e.g., fingerprint data, DNA data, facial recognition data, scan of machine-readable code, or the like). In still other examples, data from a linked device (e.g., recent heart rate data, recent blood pressure data, or the like) may be transmitted to the remote user computing device 170. The authentication data provided by the user may then be used to generate authentication response data.

At step 226, the authentication response data may be transmitted from remote user computing device 170 to dynamic authentication control computing platform 110. For instance, the authentication response data may be transmitted during the communication session initiated upon establishing the fourth wireless connection. Alternatively, if a wireless connection is not active, another wireless connection may be establishing and/or communication session initiated.

At step 227, the authentication response data may be received by dynamic authentication control computing platform 110.

At step 228, the authentication response data may be compared to pre-stored authentication data (e.g., authentication data received via the registration process). For instance, in response to the request to process an event, authentication data associated with the identified user may be retrieved from a database. That data may be compared to the authentication response data to determine whether to authorize processing of the event, authenticate the user, or the like.

At step 229, an instruction or command may be generated based on the comparing. For instance, if the authentication response data matches the pre-stored data, the user may be authenticated or the event may be authorized for processing and an instruction or command causing processing of the event may be generated. Alternatively, if the authentication response data does not match the pre-stored data, the user might not be authenticated and/or the event might be denied for processing and an instruction or command causing rejection of the requested event may be generated.

In some examples, determining whether the authentication response data matches pre-stored data may be based on a threshold of matching. For instance, if a portion of the authentication response data matches a portion of the pre-stored data, that may be sufficient to process the event (e.g., based on event details, such as an amount, type or the like). In another example, when DNA is used as an authentication factor, if the DNA response data matches pre-stored DNA by at least a threshold amount (e.g., less than 100% but more than a predetermined minimum), the event may be authorized for processing. In some examples, criteria for determining whether authentication response data matches pre-stored data may be based on an identified authentication requirement level or tier. For instance, the threshold of number of matching items or completeness of match may vary based on event details (e.g., type of event, amount, or the like), level or tier or authentication requirements, or the like.

At step 230, the generated instruction or command may be transmitted to external computing system 140. For instance, the generated instruction or command may be generated during the communication session initiated upon establishing the third wireless connection. Alternatively, another wireless connection and/or communication session may be initiated.

With reference to FIG. 2F, at step 231, the generated instruction or command may be received by external computing system 140 and may be executed (e.g., causing processing of the event or denying processing of the event).

At step 232, a notification may be generated. For instance, a notification indicating whether the requested event was processed or denied may be generated. At step 233, the generated notification may be transmitted to remote user computing device 170. At step 234, the notification may be displayed by a display of the remote user computing device 170.

At step 235, one or more machine learning datasets may be updated and/or validated (e.g., based on whether the event was processed, event details, authentication response data, and the like). Accordingly, the system may continuously update and improve determinations made by updating data used in the machine learning decisions.

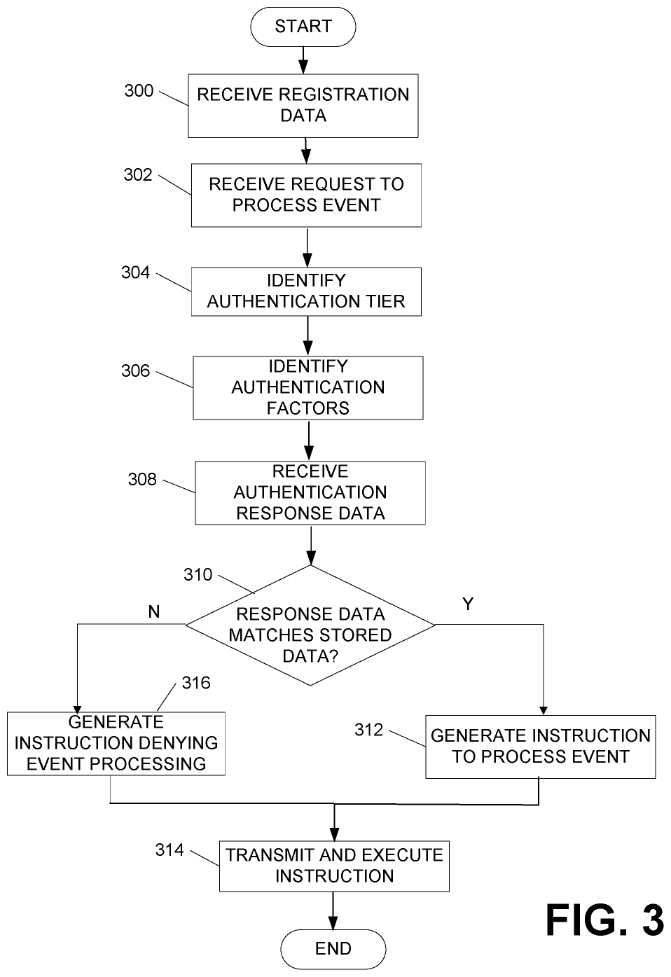

FIG. 3 is a flow chart illustrating one example method of implementing dynamic authentication control functions, according to one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described.

At step 300, registration data may be received from one or more users. As discussed herein, the registration data may include data identifying a user, contact information associated with the user, account information of the user, authenticating information of the user, and the like. In some examples, the authenticating information may include a plurality of different types of authenticating data (e.g. biometric data, username and password data, challenge question data, and the like). In some arrangements, the authenticating information may include a plurality of authentication factors for each type of authenticating data. For instance, a user may provide a plurality of different biometric authenticating factors.

In some examples, at least one authenticating factor received may include DNA of the user. The DNA may be captured via a sample provided by the user during registration (e.g., at a registration site, self-service kiosk, via a sensor on a mobile device, or the like). Additionally or alternatively, the DNA may be retrieved from a DNA storage bank with the permission of the user.

In some examples, the DNA of the user may be converted to a DNA tag that may be used for authentication. For instance, DNA of the user and/or DNA in combination with one or more other authenticating factors (e.g., pattern data, voiceprint data, password data, fingerprint data, or the like) may be converted to an alphanumeric string of characters, a machine readable code, or the like, and transmitted to the user (e.g., transmitted to a user device, embodied in a physical or tangible medium for later use, and the like).

At step 302, a request to process an event may be received. For instance, the request to process an event may include a request to authenticate a user, authorize processing of an event, such as a transaction, by authenticating the user, or the like. Some example events may include a purchase at a retailer, a request for a loan, authentication of a user to a system, or the like. In some examples, the request to process the event may be received from a retailer computing system, such as external computing system 140, from a user device, such as remote user computing device 170, or the like.

At step 304, event details may be extracted from the request to process the event and an authentication level or tier may be determined for the event. For instance, based on the event details and, in some examples, using machine learning, a level or tier or required authentication may be identified or determined. In some examples, the identified level or tier may be based on factors such as an amount of event, type of event, user preferences or selected options, and the like. The authentication tier or level may identify a number and/or type of authenticating factors required to evaluate whether the event will be processed or denied.

At step 306, authentication factors or data may be identified based on the identified authentication level or tier. For instance, based on the identified level or tier, and, in some examples, using machine learning, one or more authentication factors or data for request may be identified. The authentication factors may include particular types of authentication data (e.g., biometric data, password data, or the like), a number of each type of authentication data, a particular authentication factor, or the like. In some examples, the authentication factors identified for request may be determined dynamically based on, for instance, recency of use, frequency of use, and the like. In some arrangements, at least one identified authentication factor of the identified authentication factors may include DNA of the user. The identified authentication factors may then be transmitted to a user device, such as remote user computing device 170, for display and input from the user.

At step 308, authentication response data may be received. For instance, the user device, such as remote user computing device 170 may display the identified authentication factors requested and a user may provide user input (e.g., via the remote user computing device 170) including authenticating data corresponding to the requested authenticating factors. For instance, if a fingerprint is requested, the user may provide fingerprint data via a fingerprint scanner or sensor on the remote user computing device 170. In another example, if DNA is requested, the user may provide a DNA sample (e.g., blood, saliva, or the like) via a sensing device in the remote user computing device 170 or in communication therewith. Additionally or alternatively, if the DNA has been converted to a DNA tag as discussed herein, the user may provide a scan of the machine readable code or input the alphanumeric string corresponding to the user's DNA captured at registration.

The authentication response data may be processed to determine whether it matches the authentication data of the user provided at registration or otherwise pre-stored by the user (e.g., via a change of password, PIN, challenge question answer, or the like). For instance, the authentication response data may be compared to the pre-stored authentication data to determine whether each authentication factor received in the authentication response data matches corresponding pre-stored authentication data.

Accordingly, at step 310, a determination may be made as to whether the authentication response data matches the pre-stored data. For some types of authentication data, a match may include an exact match (e.g., password received in authentication response data exactly matches pre-stored password). Additionally or alternatively, for some types authentication data, a match may include a match of at least a pre-determined threshold amount. For instance, if a DNA sample is received, the DNA may be considered to match pre-stored DNA if it is at least a predetermined percentage match (e.g., 85%, 90%, or the like). In some examples, if multiple authentication factors are requested a match may include a match of at least a predetermined number of authentication factors (e.g., fewer than all). For instance, if four authentication factors are requested and three of the four match, the system may determine that the authentication response data sufficiently matches the pre-stored data. In some examples, the requirements of a match (e.g., of an individual authentication factor or the number of factors) may be based on the authentication level or tier, event details, user preferences, or the like.

If, at step 310, the authentication response data does not sufficiently match pre-stored data, an instruction or command to deny the requested event processing may be generated at step 316. If, at step 310, the authentication response data is determined to sufficiently match pre-stored data, an instruction or command to process the event may be generated at step 312. At step 314, the generated instruction or command may be transmitted to system from which the request to process the event was received and executed or caused to execute.

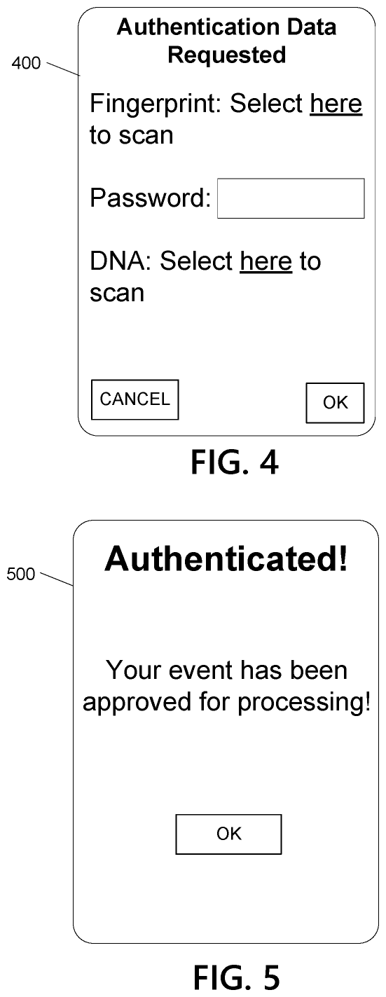

FIG. 4 illustrates one example user interface including a notification requesting user authentication data corresponding to the identified authentication factors in accordance with one or more aspects described herein. The user interface 400 includes a request for three authentication factors, though more of fewer may be requested without departing from the invention. The user may provide authentication response data for each requested authentication factor by, for example, scanning a fingerprint, providing a DNA sample or DNA tag, inputting a password, and the like. Upon completion, the user may select “OK” option to transmit the authentication response data for evaluation. Although fingerprint, DNA and password are the three authentication factors requested in the interface 400, other authentication factors may be used without departing from the invention.

FIG. 5 illustrates one example user interface including a notification indicating that the requested event has been authorized for processing. This interface 500, or a similar interface, may be transmitted to, for instance, remote user computing device 170, to provide an indication to the user that the requested event has been authorized for processing (e.g., in response to determining that the authentication response data matches the stored authentication data). If the authentication response data does not match, a notification indicating that the event has been denied processing may be generated and transmitted.

As discussed herein, aspects described relate to dynamically modifying authentication data factors to process events, authenticate a user, and the like. By dynamically determining or identifying the authenticating factors for request, the system may provide additional security to user data and further avoid exposure to unauthorized actors or activity.

As discussed herein, in at least some arrangements, DNA of the user may be used as an authenticating factor. As discussed, DNA may be captured or retrieved, e.g., during registration, and may then be used to authenticate a user. In some examples, a DNA tag may be generated by, for example, conversing the DNA data of the user to a code (e.g., alphanumeric code, machine-readable code, or the like) which may then be transmitted to the user or user computing device. The user may then submit the DNA tag as authentication response data when DNA is a requested authenticating factor.

In some arrangements, DNA data may be combined with other data to generate a unique authenticating factor for the user. For instance, data captured by a mobile device of the user, wearable device of the user, or the like, may be combined with DNA data to generate a unique authenticating factor including a combination of the data. Data such as walking gait, heart rate, blood pressure, or the like, may be captured by a user device and combined or aggregated with the DNA data to generate a unique authenticating factor that may be stored. The data may be converted to code (e.g., either individually or in combination) which may then be submitted as an authentication factor. The code may be submitted via a user device, such as a mobile device, wearable device, or the like.

Accordingly, a DNA tag may be generated from user DNA data alone or in combination with other use data (e.g., biometric data, password data, or the like) to generate a unique authenticating factor for the user. The DNA tag may be embodied as an alphanumeric code, machine-readable code (e.g., quick response (QR) code, bar code, or the like), or other human-readable or machine readable data.

As discussed herein, data may also be retrieve from various external sources. For instance, social media data of a user, other publicly available data of the user, may be captured and used to authenticate. For instance, the data from external sources may be used on its own as an authenticating factor or in combination with others. In some arrangements, data from external sources may be combined with DNA and/or other data to generate the DNA tag. In some examples, machine learning may be used to capture appropriate data from external sources. The data may be captured and used with permission of the user.

The use of DNA, either alone or in combination, may imply additional accuracy or confidence in the authentication data. For instance, if DNA data is used, alone or in combination, on its own or in a DNA tag, or the like, events processed with that authenticating factor may have an additional level of confidence due to the unique nature of DNA, difficulty in replicating by unauthorized actors, and the like.

As discussed herein, in some arrangements, authenticating factors for request may be dynamically identified upon receiving a request for event processing. As also discussed, in some examples, machine learning may be used to identifying a number and/or type of authenticating factors. In some examples, the types of authenticating factors or particular authenticating factors identified may be based on aspects such as recency of use, frequency of use, and the like. In some examples, the factors may be identified on a rolling basis such that the factor having the oldest previous use may be the first factor requested. Once that factor is used, it will become the last factor requested and the next oldest will be selected. In another example, the least frequently used authenticating factors may be selected. As those become more frequently used than other authenticating factors, the other authenticating factors will then be selected as less frequently used. Various other arrangements for selecting authenticating factors may be used without departing from the invention.

In some examples, various biometric patterns may be used as authenticating factors. For instance, biometric data such as heart rate pattern or history, blood pressure pattern or history, voice prints, walking gait, and the like may be used. In some examples, a user may be requested to confirm this data in a first use or first predetermined number of uses to confirm that is accurately represents the user. For instance, a voiceprint may be verified by the user one or more times before being used as an authenticating factor.

As also discussed herein, one or more aspects of the arrangements discussed herein may be customizable. For instance, a user may input preferences for event detail limits corresponding to an authentication level of tier, if desired. Alternatively, the system may receive standard thresholds and/or may determine thresholds from historical data.

In another example, a user may enable to disable the user of DNA or a DNA tag as an authenticating factor. The selection to enable or disable may be made via an application executing on a mobile device of the user (e.g., via a mobile banking application), via an online application (e.g., via an online banking application), or the like. The user may choose to enable use of DNA as an authenticating factor in arrangements in which he or she would prefer a heightened level of security (e.g., high dollar item events, particularly sensitive data access, or the like). The user may then disable DNA as an authenticating factor as desired (e.g., upon completion of the high dollar events, or the like). In some examples, if DNA as an authenticating factor is enabled, it may expire after a predetermined time. Alternatively, if DNA as an authenticating factor is disabled, it may be re-enabled after a predetermine time.

In some examples, machine learning may be used to enable or disable the DNA authenticating factor. For instance, machine learning may be used to analyze patterns of event processing data to determine when enhanced or heightened security may be desired and automatically enable DNA authentication.

The customization of thresholds, use of DNA, and the like, may provide additional flexibility to accommodate users with varying risk appetites.

In some examples in which use of DNA is enabled, upon requesting event processing, the user may receive a notification (e.g., on a mobile device, wearable device or the like) indicating that DNA enhanced security is enabled. In some examples, the notification may include options to proceed and/or disable the DNA enabled enhanced security aspects.

As discussed herein, user DNA may be stored by a database at, for instance, the enterprise or entity implementing the dynamic authentication control computing platform. In some examples, providing the DNA as authentication may include merely retrieving the stored DNA from the database. By accessing the stored DNA, and providing an indication to the system requesting processing of the event that stored DNA is retrieved or stored, the event processing system may automatically authorize processing the event, authenticate the user, or the like. Additionally or alternatively, the presence of the user DNA in storage and retrieved in response to an event processing request may constitute one authenticating factor (e.g., the retrieve DNA data may be considered authenticating response data corresponding to the DNA authenticating factor requested). Thus, if two or more additional authenticating factors are request, the user may provide the authentication response data for those two factors and, in combination with the stored/retrieved DNA, the user may be authenticated.

Aspects described herein may also aid in unauthorized activity detection and mitigation. For instance, in some examples, submission of authentication response data that does not match, does not match at least a particular threshold amount, repeatedly is submitted but does not match, or the like, may cause a notification to be transmitted to the user indicating potential unauthorized activity. In another example, if potential unauthorized activity is detected, the user may be prompted to input DNA or a DNA tag to authentication. In some examples, this prompt may occur even if DNA authentication is disabled, to act as an enhanced security measure.

As one example implementation of the arrangements described herein, a user may request to purchase a product valued at $20 from a retailer. The retailer system may request processing of the $20 event and the dynamic authentication control computing platform 110 may evaluate event details to determine that the event is a tier 1 event. Accordingly, one authentication factor may be required. The computing platform may dynamically identify that one factor is required and may identify the factor for use. In this example, the factor may be a PIN. The request for PIN may be transmitted to the user's mobile device (e.g., remote user computing device 170) and the user may input the PIN, which may be transmitted to the computing platform 110 for verification. If the PIN matches, the $20 event may be processed. If not, the event may be denied.

In another example, a user may request to purchase a product valued at $150 from a retailer. The retailer system may request processing of the $150 event and the dynamic authentication control computing platform 110 may evaluate event details to determine that the event is a tier 2 event. Accordingly, two authentication factor may be required. The computing platform may dynamically identify that two factors are required and may identify the factors for use. In this example, the factor may be a password and fingerprint. The request for password and fingerprint may be transmitted to the user's mobile device (e.g., remote user computing device 170) and the user may input the requested authenticating data, which may be transmitted to the computing platform 110 for verification. If the data matches, the $150 event may be processed. If not, the event may be denied.

In yet another example, a user may request to purchase a product valued at $2500 from a retailer. The retailer system may request processing of the $2500 event and the dynamic authentication control computing platform 110 may evaluate event details to determine that the event is a tier 3 event. Accordingly, three authentication factors may be required. The computing platform may dynamically identify that three factors are required and may identify the factors for use. In this example, the factor may be a PIN, DNA tag, and fingerprint. The request for authenticating data may be transmitted to the user's mobile device (e.g., remote user computing device 170) and the user may input the PIN, DNA tag and fingerprint (e.g., via one or more sensors on the mobile device) which may be transmitted to the computing platform 110 for verification. If the authenticating matches, the $2500 event may be processed. If not, the event may be denied.

The above examples are merely some example uses of the arrangements discussed herein. Various other examples may be used without departing from the invention.

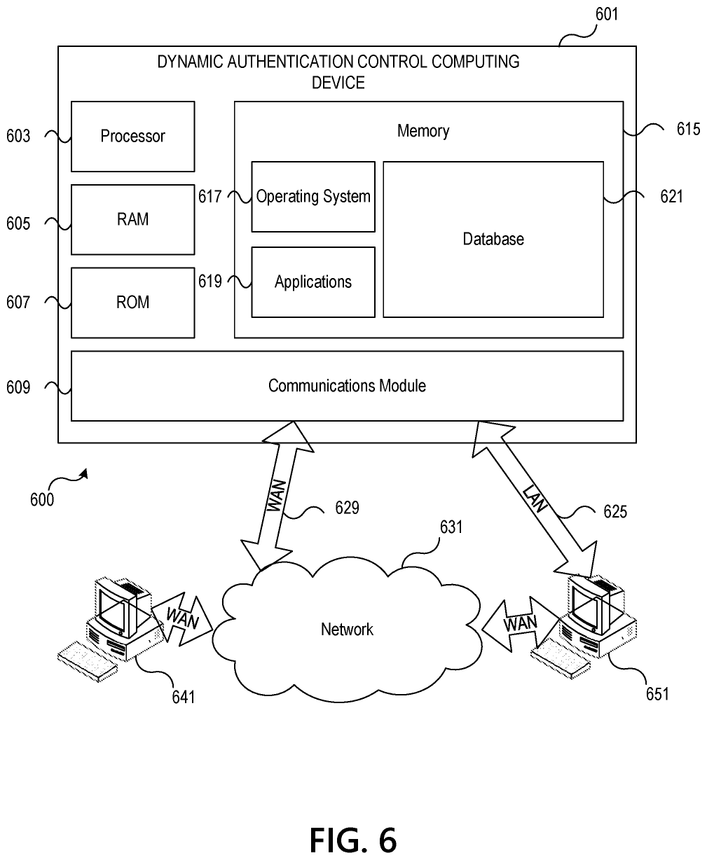

FIG. 6 depicts an illustrative operating environment in which various aspects of the present disclosure may be implemented in accordance with one or more example embodiments. Referring to FIG. 6, computing system environment 600 may be used according to one or more illustrative embodiments. Computing system environment 600 is only one example of a suitable computing environment and is not intended to suggest any limitation as to the scope of use or functionality contained in the disclosure. Computing system environment 600 should not be interpreted as having any dependency or requirement relating to any one or combination of components shown in illustrative computing system environment 600.

Computing system environment 600 may include dynamic authentication control computing device 601 having processor 603 for controlling overall operation of dynamic authentication control computing device 601 and its associated components, including Random Access Memory (RAM) 605, Read-Only Memory (ROM) 607, communications module 609, and memory 615. Dynamic authentication control computing device 601 may include a variety of computer readable media. Computer readable media may be any available media that may be accessed by dynamic authentication control computing device 601, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by dynamic authentication control computing device 601.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on dynamic authentication control computing device 601. Such a processor may execute computer-executable instructions stored on a computer-readable medium.

Software may be stored within memory 615 and/or storage to provide instructions to processor 603 for enabling dynamic authentication control computing device 601 to perform various functions as discussed herein. For example, memory 615 may store software used by dynamic authentication control computing device 601, such as operating system 617, application programs 619, and associated database 621. Also, some or all of the computer executable instructions for dynamic authentication control computing device 601 may be embodied in hardware or firmware. Although not shown, RAM 605 may include one or more applications representing the application data stored in RAM 605 while dynamic authentication control computing device 601 is on and corresponding software applications (e.g., software tasks) are running on dynamic authentication control computing device 601.

Communications module 609 may include a microphone, keypad, touch screen, and/or stylus through which a user of dynamic authentication control computing device 601 may provide input, and may also include one or more of a speaker for providing audio output and a video display device for providing textual, audiovisual and/or graphical output. Computing system environment 600 may also include optical scanners (not shown).

Dynamic authentication control computing device 601 may operate in a networked environment supporting connections to one or more remote computing devices, such as computing devices 641 and 651. Computing devices 641 and 651 may be personal computing devices or servers that include any or all of the elements described above relative to dynamic authentication control computing device 601.

The network connections depicted in FIG. 6 may include Local Area Network (LAN) 625 and Wide Area Network (WAN) 629, as well as other networks. When used in a LAN networking environment, dynamic authentication control computing device 601 may be connected to LAN 625 through a network interface or adapter in communications module 609. When used in a WAN networking environment, dynamic authentication control computing device 601 may include a modem in communications module 609 or other means for establishing communications over WAN 629, such as network 631 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

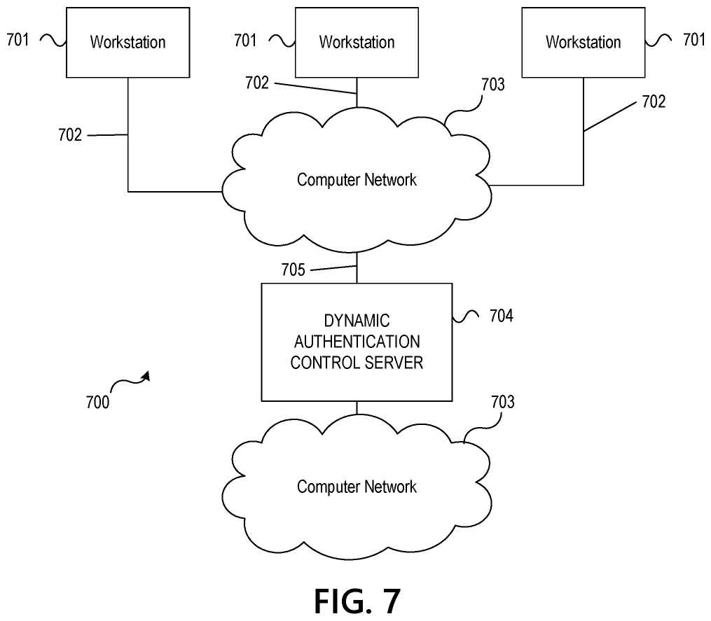

FIG. 7 depicts an illustrative block diagram of workstations and servers that may be used to implement the processes and functions of certain aspects of the present disclosure in accordance with one or more example embodiments. Referring to FIG. 7, illustrative system 700 may be used for implementing example embodiments according to the present disclosure. As illustrated, system 700 may include one or more workstation computers 701. Workstation 701 may be, for example, a desktop computer, a smartphone, a wireless device, a tablet computer, a laptop computer, and the like, configured to perform various processes described herein. Workstations 701 may be local or remote, and may be connected by one of communications links 702 to computer network 703 that is linked via communications link 705 to dynamic authentication control server 704. In system 700, dynamic authentication control server 704 may be a server, processor, computer, or data processing device, or combination of the same, configured to perform the functions and/or processes described herein. Server 704 may be used to receive registration data, receive requests to process events, identify an authentication requirement level or tier, identify authentication factors, evaluate authentication response data, generate instructions for processing or denying events, and the like.

Computer network 703 may be any suitable computer network including the Internet, an intranet, a Wide-Area Network (WAN), a Local-Area Network (LAN), a wireless network, a Digital Subscriber Line (DSL) network, a frame relay network, an Asynchronous Transfer Mode network, a Virtual Private Network (VPN), or any combination of any of the same. Communications links 702 and 705 may be communications links suitable for communicating between workstations 701 and dynamic authentication control server 704, such as network links, dial-up links, wireless links, hard-wired links, as well as network types developed in the future, and the like.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive registration data associated with a user, the registration data including authentication data of the user, the authentication data of the user including at least deoxyribonucleic acid (DNA) data of the user;
store the authentication data in a database;
receive, from a computing system, a request to process an event;
extract event details from the request to process the event;
based on the event details, and using machine learning, identify an authentication tier associated with the event;
based on the identified authentication tier, and using machine learning, identify a plurality of authentication factors, the plurality of authentication factors including at least DNA data of the user;
transmit a request for the identified plurality of authentication factors;
receive authentication response data, the authentication response data including DNA response data of the user;
compare the authentication response data to the stored authentication data to determine whether the authentication response data matches the stored authentication data, the comparing including at least comparing the DNA response data of the user to the DNA data of the user in the stored authentication data;
responsive to determining that the authentication response data matches the stored authentication data:
generate an instruction to process the event;
transmit the instruction to process the event to the computing system; and
cause the instruction to process the event to execute by the computing system;
responsive to determining that the authentication response data does not match the stored authentication data:
generate an instruction denying processing of the event;
transmit the instruction denying processing of the event to the computing system; and
cause the instruction denying processing of the event on the computing system.

2. The computing platform of claim 1, further including instructions that, when executed, cause the computing platform to:
convert the DNA data of the user in the received registration data to a DNA tag; and
transmit the DNA tag to the user,
wherein the DNA response data includes the DNA tag of the user.

3. The computing platform of claim 2, wherein converting the DNA data of the user in the received registration data to the DNA tag includes converting the DNA data of the user to an alphanumeric code.

4. The computing platform of claim 2, wherein converting the DNA data of the user in the received registration data to the DNA tag includes converting the DNA data of the user to a machine-readable code.

5. The computing platform of claim 1, wherein the authentication response data includes authentication data corresponding to each authentication factor of the plurality of authentication factors.

6. The computing platform of claim 1, wherein identifying the plurality of authentication factors includes dynamically identifying the plurality of authentication factors based on at least one of: recency of use by the user or frequency of use by the user.

7. The computing platform of claim 1, wherein criteria to determine whether the authentication response data matches the stored authentication data is based on the identified authentication tier.

8. A method, comprising:
receiving, by a computing platform having a memory and at least one processor, registration data associated with a user, the registration data including authentication data of the user, the authentication data of the user including at least deoxyribonucleic acid (DNA) data of the user;
storing, by the at least one processor, the authentication data in a database;
receiving, by the at least one processor and from a computing system, a request to process an event;
extracting, by the at least one processor, event details from the request to process the event;
based on the event details, and using machine learning, identifying, by the at least one processor, an authentication tier associated with the event;
based on the identified authentication tier, and using machine learning, identifying, by the at least one processor, a plurality of authentication factors, the plurality of authentication factors including at least DNA data of the user;
transmitting, by the at least one processor, a request for the identified plurality of authentication factors;
receiving, by the at least one processor, authentication response data, the authentication response data including DNA response data of the user;
comparing, by the at least one processor, the authentication response data to the stored authentication data to determine whether the authentication response data matches the stored authentication data, the comparing including at least comparing the DNA response data of the user to the DNA data of the user in the stored authentication data;
when it is determined that the authentication response data matches the stored authentication data:
generating, by the at least one processor, an instruction to process the event;
transmitting, by the at least one processor, the instruction to process the event to the computing system; and
causing the instruction to process the event to execute by the computing system;
when it is determined that the authentication response data does not match the stored authentication data:
generating, by the at least one processor, an instruction denying processing of the event;
transmitting, by the at least one processor, the instruction denying processing of the event to the computing system; and
causing the instruction denying processing of the event on the computing system.

9. The method of claim 8, further including:
converting, by the at least one processor, the DNA data of the user in the received registration data to a DNA tag; and
transmitting, by the at least one processor, the DNA tag to the user,
wherein the DNA response data includes the DNA tag of the user.

10. The method of claim 9, wherein converting the DNA data of the user in the received registration data to the DNA tag includes converting the DNA data of the user to an alphanumeric code.

11. The method of claim 9, wherein converting the DNA data of the user in the received registration data to the DNA tag includes converting the DNA data of the user to a machine-readable code.

12. The method of claim 9, wherein the authentication response data includes authentication data corresponding to each authentication factor of the plurality of authentication factors.

13. The method of claim 9, wherein identifying the plurality of authentication factors includes dynamically identifying the plurality of authentication factors based on at least one of: recency of use by the user or frequency of use by the user.

14. The method of claim 9, wherein criteria to determine whether the authentication response data matches the stored authentication data is based on the identified authentication tier.

15. One or more non-transitory computer-readable media storing instructions that, when executed by a computing platform comprising at least one processor, memory, and a communication interface, cause the computing platform to:
receive registration data associated with a user, the registration data including authentication data of the user, the authentication data of the user including at least deoxyribonucleic acid (DNA) data of the user;
store the authentication data in a database;
receive, from a computing system, a request to process an event;
extract event details from the request to process the event;
based on the event details, and using machine learning, identify an authentication tier associated with the event;
based on the identified authentication tier, and using machine learning, identify a plurality of authentication factors, the plurality of authentication factors including at least DNA data of the user;
transmit a request for the identified plurality of authentication factors;
receive authentication response data, the authentication response data including DNA response data of the user;
compare the authentication response data to the stored authentication data to determine whether the authentication response data matches the stored authentication data, the comparing including at least comparing the DNA response data of the user to the DNA data of the user in the stored authentication data;
responsive to determining that the authentication response data matches the stored authentication data:
generate an instruction to process the event;
transmit the instruction to process the event to the computing system; and
cause the instruction to process the event to execute by the computing system;
responsive to determining that the authentication response data does not match the stored authentication data:
generate an instruction denying processing of the event;
transmit the instruction denying processing of the event to the computing system; and
cause the instruction denying processing of the event on the computing system.

16. The one or more non-transitory computer-readable media of claim 15, further including instructions that, when executed, cause the computing platform to:
convert the DNA data of the user in the received registration data to a DNA tag; and
transmit the DNA tag to the user,
wherein the DNA response data includes the DNA tag of the user.

17. The one or more non-transitory computer-readable media of claim 16, wherein converting the DNA data of the user in the received registration data to the DNA tag includes converting the DNA data of the user to an alphanumeric code.

18. The one or more non-transitory computer-readable media of claim 16, wherein converting the DNA data of the user in the received registration data to the DNA tag includes converting the DNA data of the user to a machine-readable code.

19. The one or more non-transitory computer-readable media of claim 15, wherein the authentication response data includes authentication data corresponding to each authentication factor of the plurality of authentication factors.

20. The one or more non-transitory computer-readable media of claim 15, wherein identifying the plurality of authentication factors includes dynamically identifying the plurality of authentication factors based on at least one of: recency of use by the user or frequency of use by the user.

21. The one or more non-transitory computer-readable media of claim 15, wherein criteria to determine whether the authentication response data matches the stored authentication data is based on the identified authentication tier.
